(19) United States
(12) Patent Application Publication
(10) Pub. No.: US 2005/0048945 A1
(43) Pub. Date: Mar. 3, 2005

(54) Emergency call system and method

(76) Inventor: Robert Porter, Plano, TX (US)

Correspondence Address: Michael L. Diaz;Michael L. Diaz, P.C., Suite 200, 555 Republic Drive, Plano, TX, 75074, US

(21) Appl. No.: 10/650,408

(22) Filed: Aug. 27, 2003

(51) Int. Cl. H04M 1/00

(52) U.S. Cl. 455/404.1; 455/564

(57) ABSTRACT

An emergency call system for automatically calling a specified number. The emergency call system includes a transmitting unit carried by an individual. The transmitting unit includes an on/off switch and a microphone. The system also includes a mobile phone and a receiving unit communicating with the transmitting unit and the mobile phone. The individual actuates the on/off switch of the transmitting unit to send a signal to the receiving unit. The receiving unit then sends a signal to the mobile phone to dial a telephone number specified by the individual. The mobile phone dials the specified number and connects a one-way call from the transmitting unit to the telephone number to provide audio signals from the transmitting unit to the specified telephone number.

### BACKGROUND OF THE INVENTION

1. Technical Field of the Invention

This invention relates to call systems, and more particularly, to an emergency call system and method providing an audio recording.

2. Description of Related Art

Each year, many people are assaulted or robbed without any ability to call for help. Mobile phones have helped to some extent in providing some way for an individual to call for help. However, there are some limitations with current mobile phones. First, if a crime or other undesirable act is being committed by third parties, the individual is oftentimes unable to call a specific emergency number because the criminal third party is alerted and will not allow an individual to place the call. Second, calling an emergency number generally requires the pressing of several buttons, which may not allow an individual sufficient time to initiate and complete the call. Third, for persons wishing to use a commercially available automated dialing device to expedite the calling process to 911 centers, they are prohibited form doing so in no less than ten states that have passed false alarm laws against devices that automatically dial 911. Fourth, if a speed call should be successfully placed from a mobile phone to 911, which is legally permissible since it allows for two way communications with the 911 operator, then the caller's danger is heightened because the attacker can become aware of the call by hearing the 911 operator or seeing an activated phone in the possession of his victim. Also, when the call is connected to an emergency number, currently there is no way to record a conversation or sounds from events unfolding at the scene of the crime in the critical seconds while the call is being connected. It would be advantageous to have a device which allows an individual to quickly and without notice to others, a way to connect an emergency phone call while simultaneously recording any sounds.

Although there are no known prior art teachings of a solution to the aforementioned deficiency and shortcoming such as that disclosed herein, prior art references that discuss subject matter that bears some relation to matters discussed herein are U.S. Pat. No. 5,305,370 to Kearns et al. (Kearns), U.S. Pat. No. 5,333,172 to Stevens (Stevens), and U.S. patent Publication No. US 2001/0017912 to Baum et al. (Baum).

Kearns discloses a personal emergency response system in which a portable transmitter activates a base unit interfaced with a telephone network to dial 9-1-1 and communicate with an emergency operator. However, Kearns does not teach or suggest a hidden device enabling a person to covertly initiate an emergency call, which is of huge practical significance. In addition, Kearns does not teach or suggest a service center to record any sounds transmitted from an individual initiating the emergency call. Kearns also suffers from the disadvantage of requiring a fixed base station wired to a fixed telephone, thereby limiting the range of the system.

Stevens discloses an apparatus for emergency dialing and one-way communication by telephone. The apparatus includes an autodialing circuit for dialing a preselected emergency telephone. The circuit is activated by a switch and provides communication of audio information from the vicinity of the device to an emergency operator. The apparatus has a microphone, but lacks a speaker. However, Stevens does not teach or suggest a service center to record the individual initiating the emergency call. Stevens also does not teach or suggest the use of a mobile phone to allow transmissions away from a landline phone, which is a major technological shift with significant technical challenges due to the requirement for totally hands-free voice activated cell phone dialing.

Baum discloses an emergency call system by which a caller can automatically call a plurality of other parties to leave an emergency message. The call system includes an emergency call unit having a memory for storing telephone numbers to be called and an emergency message. After the call is initiated, the telephone number is dialed upon activation of an emergency key, which starts a transmission of the emergency message to the dialed telephone number. Baum does not teach or suggest a hidden device for initiating the call. In addition, Baum does not teach or suggest a service center which may record any sounds around the vicinity of the call originator. Additionally, the practical value of hearing an actual live voice of a caller compared to a voice mail message is a significant difference.

None of the references or any existing emergency call systems enables an individual to covertly initiate an emergency call while roaming from a fixed location, make a legally permissible automated call, and make an audio recording of sounds within the vicinity of the call originator. Thus, it would be a distinct advantage to have a system and method which provides an emergency call system and audio recording of sounds within the vicinity of the call originator in a covert manner. It is an object of the present invention to provide such a system and method.

### SUMMARY OF THE INVENTION

In one aspect, the present invention is an emergency call system. The emergency call system includes a transmitting unit carried by an individual. The transmitting unit has an on/off switch and a microphone. The system also includes a mobile phone and a receiving unit communicating with the transmitting unit and the mobile phone. The individual actuates the on/off switch of the transmitting unit to send a signal to the receiving unit. The receiving unit then sends a signal to the mobile phone to dial a telephone number specified by the individual. The mobile phone dials the specified number and connects a one-way call from the transmitting unit to the telephone number to provide audio signals received within the microphone to the specified telephone number.

In another aspect, the present invention is a method of completing an emergency call within an emergency call system. The system has a transmitting unit carried by an individual communicating with a receiving unit which communicates with a mobile phone. The method begins by the individual actuating the transmitting unit. Next, a signal is sent from the transmitting unit to the receiving unit. A command is then sent by the receiving unit of the mobile phone to dial a specified telephone number. Next, the mobile phone dials the specified telephone number. The call is then completed between the transmitting unit to the specified telephone number. Audio signals received by a microphone in the transmitting unit are sent to the specified telephone number.

In still another aspect, the present invention is an emergency call system. The system includes a transmitting unit carried by an individual. The transmitting unit has an on/off switch and a microphone. The system also includes a mobile phone having a voice activation system and a receiving unit communicating with the transmitting unit and the mobile phone. In addition, the system also includes a service center having the specified telephone number. The individual actuates the on/off switch of the transmitting unit to send a signal to the receiving unit. The receiving unit sends a signal to the voice activation system of the mobile phone to dial the telephone number specified by the individual. The mobile phone then dials the specified number and connects a one-way call from the transmitting unit to the service center to provide audio signals received within the microphone to the specified telephone number. The service center then records the received audio signals. It also includes a mechanism for ensuring that the receiving unit continues to call until a call is completed.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a simplified block diagram illustrating the components of an emergency call system in the preferred embodiment of the present invention;

FIG. 2 is a front view of the transmitting unit;

FIG. 3 is a side view of the transmitting unit;

FIG. 4 is a block diagram of internal components of the transmitting unit;

FIG. 5 is a front view of the receiving unit;

FIG. 6 is a side view of the receiving unit;

FIG. 7 is a bottom view of the receiving unit;

FIG. 8 is a simplified block diagram of internal components of the receiving unit;

FIG. 9 is a side view of a plurality of cables which may be used with the receiving unit; and

FIGS. 10A-C are flow charts outlining the steps for calling an emergency number and recording sounds within the vicinity of the caller according to the teachings of the present invention.

### DETAILED DESCRIPTION OF EMBODIMENTS

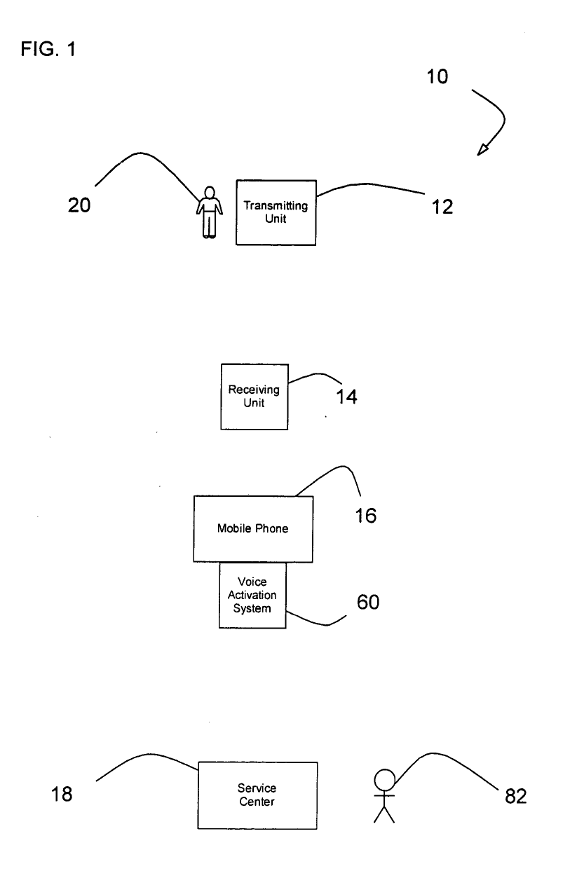

A system and method of initiating an emergency call and recording events around a call originator is disclosed. FIG. 1 is a simplified block diagram illustrating the components of an emergency call system 10 in the preferred embodiment of the present invention. The emergency call system includes a transmitting unit 12, a receiving unit 14, a mobile phone 16, and a service center 18.

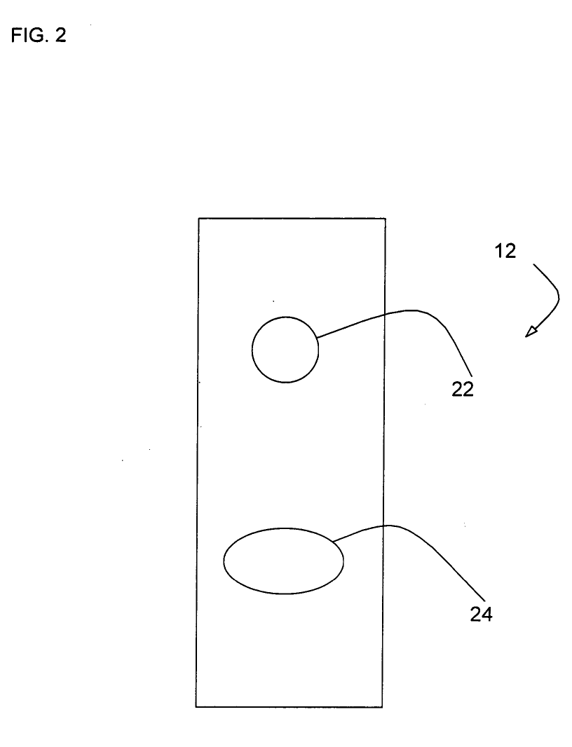

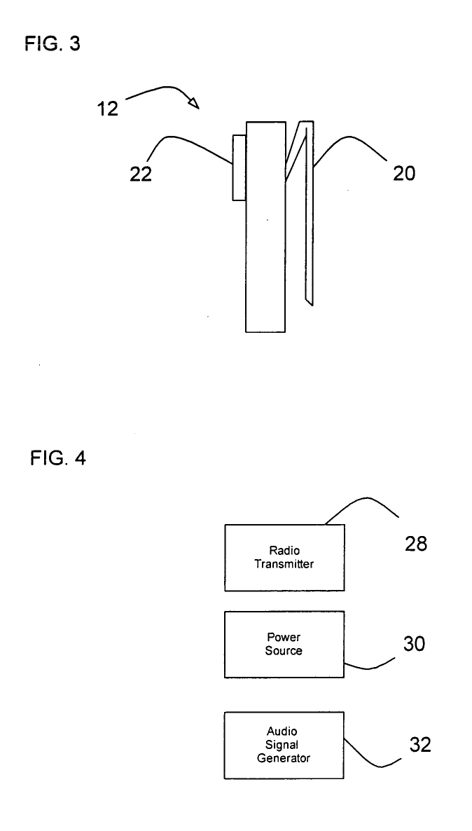

FIG. 2 is a front view of the transmitting unit 12. FIG. 3 is a side view of the transmitting unit 12. FIG. 4 is a block diagram of internal components of the transmitting unit 12. The transmitting unit 12 is preferably sized and shaped to unobtrusively fit in a pocket or purse of an individual 20. The transmitting unit includes a miniature microphone 22, a transmitter on/off switch 24, and an optional clipping device 26. In addition, the transmitting unit includes a radio transmitter 28, a power source 30 and an audio signal generator 32. The power source may be any power source enabling the transmitting unit to transmit sounds received by the microphone. The clipping device 26 may be used to attach the transmitting unit to clothing of the individual, such as a belt, purse or bra worn by the individual. The transmitting unit preferably transmits, via the radio transmitter, to the receiving unit audio signals received by the microphone on any standard radio frequency, such as 900 MHz. However, it should be understood by those skilled in the art of radio transmission, that any device may be used which enables an individual to transmit sounds to the receiving unit 14. To prevent crosstalk with other transmitters/receivers, in the preferred embodiment of the present invention, the transmitter transmits a signal on a specific frequency or with a specific code for which the receiver responds. In an alternate embodiment of the present invention, the transmitting unit may include the microphone attached by a wire to the main chassis of the transmitting unit, thereby allowing the microphone to be positioned in a different location than the main chassis.

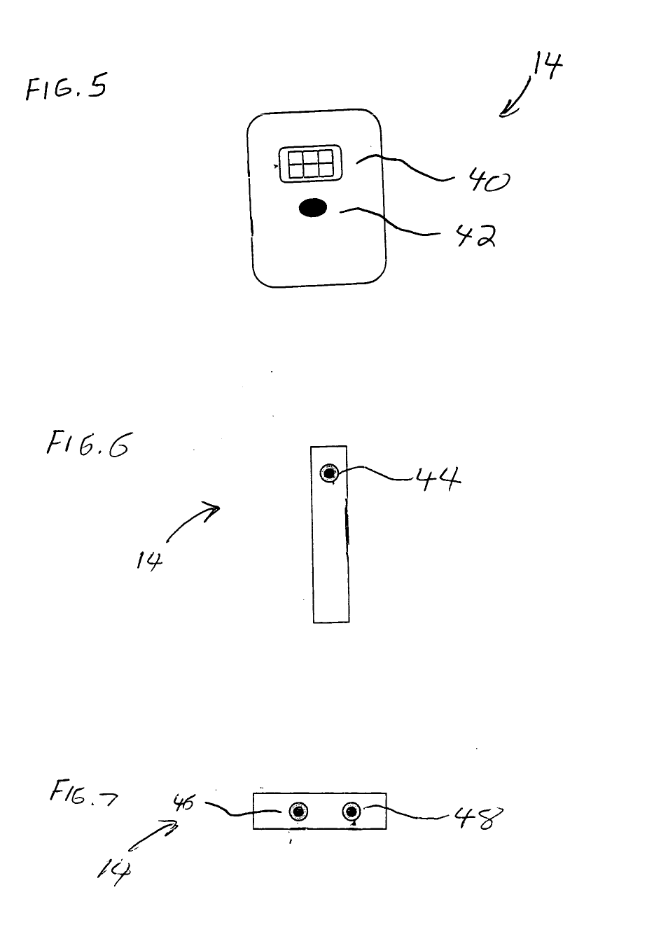

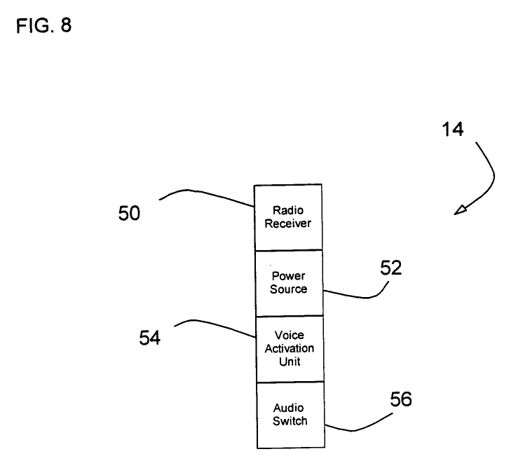

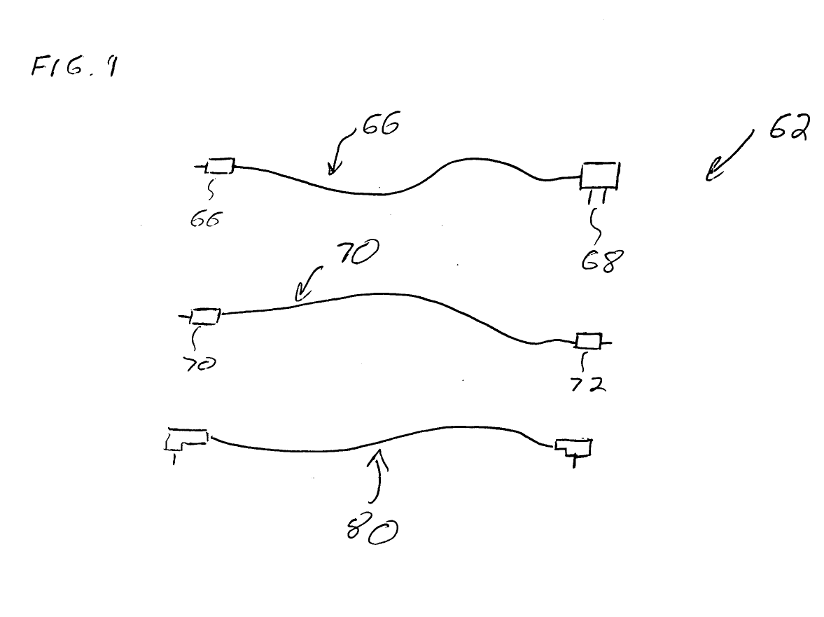

FIG. 5 is a front view of the receiving unit 14. FIG. 6 is a side view of the receiving unit. FIG. 7 is a bottom view of the receiving unit. FIG. 8 is a simplified block diagram of internal components of the receiving unit. The receiving unit includes an optional channel selector readout 40, a receiver on/off switch 42, an audio output jack 44, a power out jack 46, and a power inlet jack 48. The receiving unit also includes a radio receiver 50, a power source 52, a voice activation unit 54, and an audio switch 56. The power source may be any power source enabling the reception of audio signals from the transmitting unit 12 and the activation of voice activated dialing to the mobile phone 16. The radio receiver 50 enables reception of signals transmitted by the transmitting unit 12.

In the preferred embodiment of the present invention, the audio switch 56 provides the individual 20 the ability to select two different emergency call numbers. The audio switch provides a selector, which may be embodied as a mechanical or electrical switch for selection an audio signal 1 or audio signal 2. Each audio signal provides the requisite voice activation signal to select a telephone number stored within the mobile phone 16's voice activation system 60. The selected audio signal may be optionally displayed on the channel selector readout 40.

FIG. 9 is a side view of a plurality of cables 62 which may be used with the receiving unit 14. A power cable 64 having an input jack 66 and a power cable jack 68 may be used to provide power for recharging the power source 52. The input jack 66 may be inserted into the power inlet jack 48. The power cable jack 68 may be inserted into a standard AC electrical outlet. An audio cable 70 may be used to connect the receiving unit to the mobile phone 16. The audio cable includes a receiver connection jack 72 inserted into the audio output jack 44 of the receiving unit. The audio cable also includes a mobile phone jack 74 for insertion into the earphone port (not shown) of the mobile phone. The audio cable enables the receiving unit to send a selected audio signal to the mobile phone for voice activation dialing through the voice activation system 60. A power to phone cable 80 provides an optional connection between the mobile phone and the receiving unit. Because of the setup of many conventional mobile phones, in order to activate the voice activation system, there must be a common power supply between the mobile phone and the receiver unit.

The mobile phone 16 may be any communication device which providing the transmission of audio signals, namely sounds generated within the vicinity of the individual 20. The mobile phone preferably includes the voice activation system 60 enabling the voice dialing of a number. The voice activation system is commonly found in many mobile phones and is well known to those skilled in the art of telecommunications. Although a voice activation system is preferred, in an alternate embodiment of the present invention, the selected telephone number may be dialed through a data signal generated by the receiving unit directly to the mobile phone.

The service center 18 receives the phone call from the mobile phone 16. Since the transmitting unit continues to send audio received from the microphone 22, the service center receives the audio signals. Once the call is connected between the service center and the mobile phone, the service center automatically begins recording the received audio. In addition, the service center may be staffed by trained emergency response counselors, or another designated staff individual 82. This staff individual may listen to the events transpiring around the transmitting unit and take appropriate action (e.g., dispatch police or ambulance). In addition, the service center may also have the ability to track the mobile phone and provide information to emergency response teams, such as the police or ambulance. The service center may optionally provide the ability for the staff individual to conduct a two-way conversation with the individual through the mobile phone.

With reference to FIGS. 1-9, the operation of the emergency call system 10 will now be explained. Prior to using the emergency call system 10, the mobile phone 16 and the receiving unit 14 must be turned on. The individual sets the desired emergency call destination by selecting the desired audio signal from the audio switch 56. The selected audio signal is shown on the channel selector readout 40. The receiving unit is attached to the mobile phone by the audio cable 70. The power to phone cable 80 is supplied to enable the cell phone to operate in a hands free mode comparable to using the cell phone hands-free in a car. Current cell phone technology requires a “closing of the circuit” through a hardwired power source such as a wall outlet or car cigarette lighter for the cell phone to receive a voice command without touching a headset command key. The transmitting unit is worn or carried by the individual 20. The transmitting unit may be hidden in a pocket, jewelry or other article or clothing. The mobile phone does not need to be carried by the individual. However, in the preferred embodiment of the present invention, the transmitting unit may only transmit to a range of approximately 200 feet. Therefore, to effectively operate, the mobile phone should be near the individual.

When in danger, the individual 20 actuates the emergency call system 10 by actuating the on/off switch 24 to the on position. The transmitting unit then immediately sends a signal via the radio transmitter 28 to the receiving unit 14. The receiving unit receives the signal and generates an audio signal as selected by the audio switch 56. The receiving unit, through the audio signal generator 32, then generates the appropriate audio signal and sends the selected audio signal to the mobile phone.

The mobile phone 16 receives the audio signal through the voice activation system 60 embedded within the mobile phone. The voice activation system is activated to automatically dial the desired emergency number selected by the individual 20. The emergency number may be any number, such as a close friend, or preferably the service center 18. Upon dialing the emergency number, an internal timer located in the receiving unit starts. After a predetermined time period (e.g., 20 seconds), the voice activation system is prompted to redial the second emergency number if the call is not connected on the first attempt. This process is repeated until the call is completed to one of the two designated numbers. Both numbers may actually be the same number-so that all calls are placed to the same number until completed.

Upon connection with the called number, if the called number is the service center 18, the service center recognizes the caller through caller ID as either a registered client or a non-registered client. The caller ID assists in processing the call by the staff individual 82 by facilitating a database lookup for the caller ID and immediately providing the staff individual the personalized profile for the client. In addition, upon connection of the call, the service center begins recording any sounds transmitted by the transmitting unit. At this point, upon call completion, the microphone picks up voice or sounds of the caller and transmits these sounds to the service center. The service center, through the staff individual, may take appropriate action depending on what is heard. With the connection of the call, the service center may optionally send a signal to the mobile phone, which is transferred to the receiving unit, to indicate that the call is completed. The internal timer may then be turned off, thus discontinuing attempts to dial the emergency number. In addition, the call completion signal may initiate a signal by the receiving unit to the mobile phone to turn the voice activation system off, thus preventing voice activation of the mobile phone.

With the call completed, there is an open microphone, which does not show any visible display through the transmitting unit. Thus, the individual may transmit a help signal without alerting the assailant or dangerous person/persons of the emergency call. No visible indicator is present on the transmitting unit to indicate a call initiation or call completion.

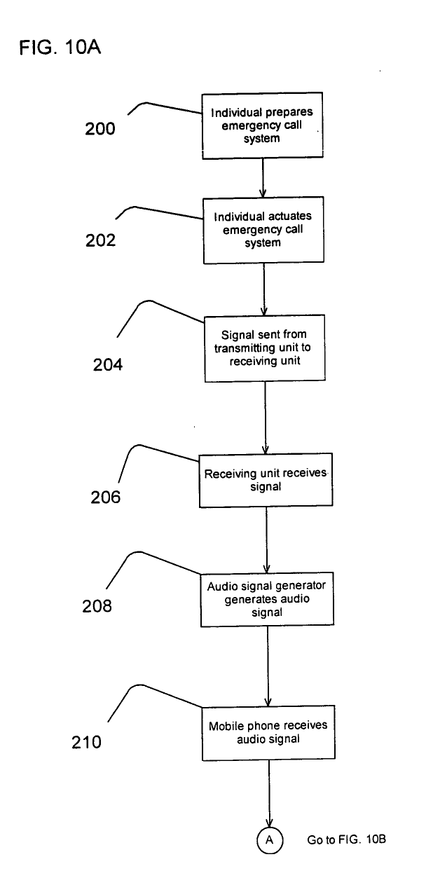

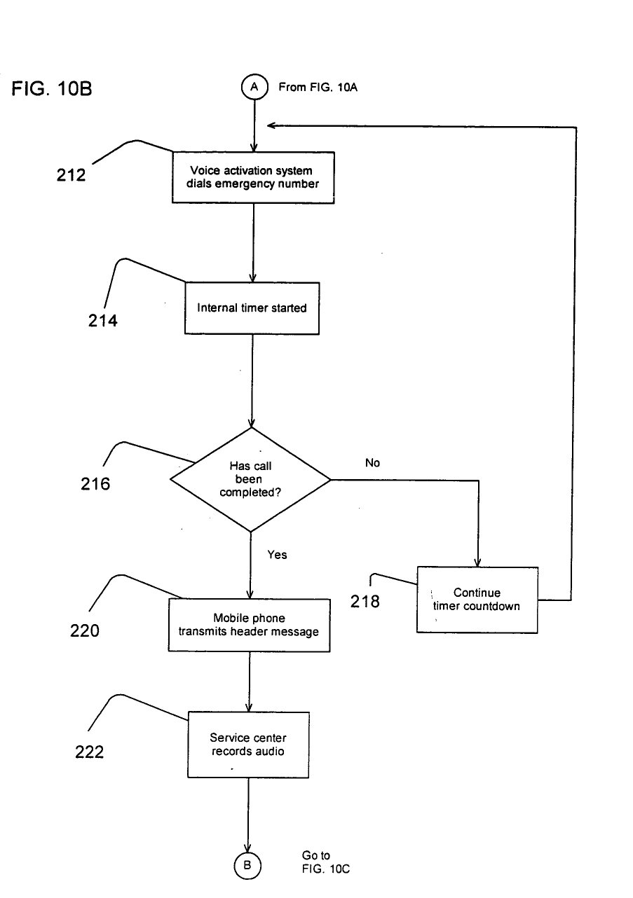

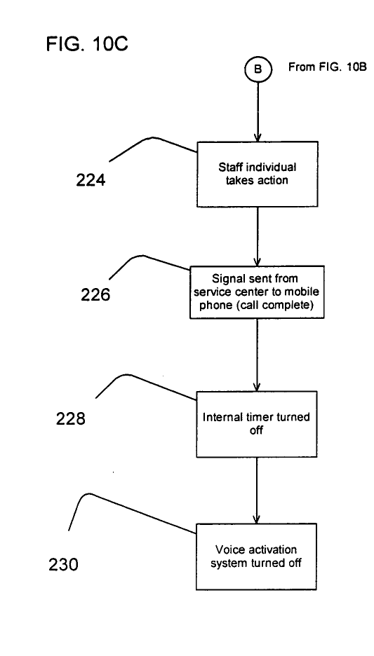

FIGS. 10A-C are flow charts outlining the steps for calling an emergency number and recording sounds within the vicinity of the caller according to the teachings of the present invention. With reference to FIGS. 1-9, 10A, 10B and 10C, the steps of the method will now be described. Beginning with step 200, the individual 20 prepares the emergency call system 10. The individual turns on the mobile phone 16 and the receiving unit 14. In addition, the individual sets the desired emergency call destination by selecting the approximate audio signal from the audio switch 56. The selected audio signal is shown on the channel selector readout 40. The receiving unit is attached to the mobile phone by the audio cable 70 and the power to phone cable 80. The transmitting unit is worn or carried by the individual 20. The transmitting unit may be hidden in a pocket, jewelry or other article or clothing. The mobile phone does not need to be carried by the individual. However, in the preferred embodiment of the present invention, the transmitting unit may only transmit to a range of approximately 200 feet. Therefore, the transmitting unit should remain relatively close to the mobile phone.

Next, in step 202, when the individual senses danger or requires an audio recording, the individual 20 actuates the emergency call system 10 by actuating the on/off switch 24 to the on position. The method then moves to step 204 where a signal is sent from the transmitting unit to the receiving unit. In step 206, the receiving unit receives the signal transmitted by the transmitting unit.

In step 208, the audio signal generator 32 generates the appropriate audio signal and sends the selected audio signal to the mobile phone 16. In step 210, the mobile phone 16 receives the audio signal through the voice activation system 60 embedded within the mobile phone. Next, in step 212, the voice activation system is activated to automatically dial the desired emergency number selected by the individual 20. The emergency number may be any number, such as a close friend, or preferably the service center 18. In step 214, upon dialing the emergency number, an internal timer located in the receiving unit begins a countdown.

Next, in step 216, it is determined if the emergency call has been completed. If the emergency call has not been completed, the method moves to step 218 where the method continues to wait until the timer has completed the countdown. Once the specified time has elapsed, the method moves back to step 212 where the voice activation system is activated to automatically dial the desired emergency number.

However, in step 216, if it is determined that the emergency call has been completed, the method moves from step 216 to step 220 where the mobile phone optionally transmits a header message to the destination number. The header message provides information on the calling party, individual 20, which may assist in processing the call by the staff individual 82. Next, in step 222, upon connection of the call, the service center automatically begins recording any sounds transmitted by the transmitting unit. At this point, upon call completion, the microphone picks up sounds (preferably within a radius of approximately 10 feet) and transmits these sounds to the service center. In step 224, the service center, through the staff individual, may optionally take appropriate action depending on what is heard. In addition, in step 226, with the connection of the call, the service center may optionally send a signal to the mobile phone, which is transferred to the receiving unit, to indicate that the call is completed. In step 228, the internal timer may then be turned off, thus discontinuing attempts to dial the emergency number. In addition, in step 230, the call completion signal may initiate a signal by the receiving unit to the mobile phone to turn the voice activation system off, thus preventing voice activation of the mobile phone.

With the call completed, there is an open microphone. Thus, the individual may transmit a help signal without alerting the assailant or dangerous person/persons of the emergency call. No visible indicator is present on the transmitting unit to indicate a call initiation or call completion.

In an alternate embodiment of the present invention, the mobile phone 16 or the receiving unit 14 may include a buffer to store audio signals received from the transmitting unit 12. Prior to completion of the emergency call, the transmitting unit may receive audio from the microphone 22. In order to capture such recordings, the mobile phone/receiving unit may store the audio for transmission to the service center or called party upon completion of the call. In another embodiment of the present invention, the receiving unit may be incorporated into the mobile phone. Thus, the mobile phone may receive directly from the transmitting unit any received signals.

The present invention provides many benefits over existing call systems. The present invention enables an individual to covertly call an emergency number, allow an independent party to analyze any received sounds to determine a course of action (e.g., call for police or emergency response teams), and record any received sounds for later use by law enforcement or legal proceedings. The present invention enables an individual to accomplish this emergency calling away from a fixed location. In addition, a small, unobtrusive microphone is utilized to provide adequate sound pickup in a covert manner. In addition, the transmitting unit enables the individual to covertly initiate the call by the mere actuation of a single button. The present invention may be incorporated within a conventional mobile phone.

It is thus believed that the operation and construction of the present invention will be apparent from the foregoing description. While the system and method shown and described has been characterized as being preferred, it will be readily apparent that various changes and modifications could be made therein without departing from the scope of the invention as defined in the following claims.

1. An emergency call system, said system comprising:
a transmitting unit carried by an individual, said transmitting unit having an on/off switch and a microphone;
a mobile phone; and
a receiving unit communicating with said transmitting unit and said mobile phone;
whereby the individual actuates the on/off switch of said transmitting unit to send a signal to said receiving unit, said receiving unit sending a signal to said mobile phone to dial a telephone number specified by the individual, said mobile phone dialing the specified number and connecting a one-way call from said transmitting unit to the telephone number to provide audio signals received from the microphone to the specified telephone number.

2. The emergency call system of claim 1 further comprising a service center associated with the specified telephone number.

3. The emergency call system of claim 2 wherein said service center has an audio recording to record all audio signals received from said transmitting unit.

4. The emergency call system of claim 2 wherein said service center includes at least one staff member monitoring received audio signals from said transmitting unit, said staff member providing appropriate assistance to the individual based upon monitored received audio signals.

5. The emergency call system of claim 4 wherein said staff member communicates via said mobile phone with the individual, thereby providing a two-way call to the individual.

6. The emergency call system of claim 1 wherein said mobile phone includes a buffer for storing received audio signals from said transmitting unit prior to call completion.

7. The emergency call system of claim 1 wherein said receiving unit includes a buffer for storing received audio signals from said transmitting unit prior to call completion.

8. The emergency call system of claim 1 wherein said receiving unit is integrated into said mobile phone.

9. The emergency call system of claim 1 wherein said mobile phone includes a voice activation system which automatically dials a specified telephone number upon receipt of a specified voice activation signal;
said receiving unit generating a specified voice activation signal upon receipt of the signal from the transmitting unit.

10. The emergency call system of claim 9 wherein said receiving unit includes an audio signal selector, the selector enabling the individual to select one of at least two telephone numbers.

11. The emergency call system of claim 10 wherein said receiving unit includes an audio selector indicator to indicate the selected telephone number.

12. The emergency call system of claim 1 wherein said mobile phone sends a header message providing information on the individual to the specified telephone number.

13. The emergency call system of claim 1 further comprising a timer, said timer being initiated upon said mobile phone dialing the specified telephone number; and
wherein said mobile phone dials the specified telephone number upon passage of a specified time period determined by the timer.

14. The emergency call system of claim 1 further comprising a service center having the specified telephone number; and
wherein said service center responds to completion of the one-way call by sending a call complete message to said mobile phone.

15. A method of completing an emergency call within an emergency call system, said system having a transmitting unit carried by an individual communicating with a receiving unit communicating with a mobile phone, the method comprising the steps of:
actuating the transmitting unit by the individual;
sending a signal from the transmitting unit to the receiving unit;
sending a command by the receiving unit to the mobile phone to dial a specified telephone number;
dialing by the mobile phone the specified telephone number;
completing the call between the transmitting unit to the specified telephone number; and
sending audio signals received by a microphone in the transmitting unit to the specified telephone number.

16. The method of completing an emergency call of claim 15 wherein the step of dialing by the mobile phone the specified telephone number includes the mobile phone dialing a service center having the specified telephone number.

17. The method of completing an emergency call of claim 16 further comprising, after the step of sending audio signals received by a microphone in the transmitting unit to the specified telephone number, the step of recording the audio signals by the service center.

18. The method of completing an emergency call of claim 15 wherein the step of sending a command by the receiving unit to the mobile phone to dial a specified telephone number includes sending a command to a voice activation system within the mobile phone for dialing the specified number.

19. The method of completing an emergency call of claim 15 further comprising, before the step of actuating the transmitting unit by the individual, the step of selecting a desired telephone number from an audio signal selector.

20. An emergency call system, said system comprising:
a transmitting unit carried by an individual, said transmitting unit having an on/off switch and a microphone;
a mobile phone having a voice activation system;
a receiving unit communicating with said transmitting unit and said mobile phone; and
a service center having the specified telephone number
whereby the individual actuates the on/off switch of said transmitting unit to send a signal to said receiving unit, said receiving unit sending a signal to the voice activation system of said mobile phone to dial the telephone number specified by the individual, said mobile phone dialing the specified number and connecting a one-way call from said transmitting unit to said service center to provide audio signals received within the microphone to the specified telephone number, said service center recording the received audio signals.
